(19) United States
(12) Patent Application Publication
(10) Pub. No.: US 2005/0091553 A1
(43) Pub. Date: Apr. 28, 2005

(54) Security system and method

(76) Inventors: Chih-Feng Chien, Keelung (TW); Chen-Ming Chang, Taipei (TW)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/918,884

(22) Filed: Aug. 16, 2004

(30) Foreign Application Priority Data
Oct. 28, 2003 (TW) 092129963

(51) Int. Cl. H04K 1/00

(52) U.S. Cl. 713/324

(57) ABSTRACT

A security system includes a wireless transmitter for issuing a specific wireless signal, and a wireless receiver in communication with the computer system for receiving the specific wireless signal. The computer system works normally when the wireless receiver continuously receives the specific wireless signal, and enters a locked mode in response to the interruption of the specific wireless signal. The wireless transmitter preferably includes a switch for resetting the specific wireless signal.

### FIELD OF THE INVENTION

The present invention relates to a security system, and more particularly to a security system for use with a computer system. The present invention also relates to a security method for protecting a computer system from being arbitrarily used.

### BACKGROUND OF THE INVENTION

A security system for protecting a computer system from being arbitrarily used is useful for data security. Conventionally, the security system requires a pin or password from a user to unlock the computer when the computer is just booted or just restored to work. For example, by activating the security item in the screen saver settings, the computer, after being idle for a certain period of time, cannot be restored to normal work unless a correct pin or password has been entered. In other words, if the screen saver is frequently activated, even the qualified user has to enter the pin or password over and over to restore the computer. It is thus somewhat troublesome.

Another conventional security means controls a computer system with a security key 11 or 12, which has a configuration conforming to a connector socket of the computer system such as a universal serial bus (USB) port 13 or printer port 14, as shown in FIG. 1. When the security key is attached to the connector socket, the computer system can be operated normally. On the other hand, for avoiding arbitrary use, the security key can be removed from the connector socket to prohibit from normal work of the computer system. The insertion operation of the security key to the connector socket is troublesome or even difficult for many users.

### SUMMARY OF THE INVENTION

The present invention is to provide a security system which can achieve the security purpose in a user-friendly manner.

Therefore, the present invention a security system for use with a computer system. The security system comprises a wireless transmitter for issuing a specific wireless signal; and a wireless receiver in communication with the computer system for receiving the specific wireless signal. The computer system enters a locked mode when the wireless receiver does not receive the specific wireless signal.

Preferably, the wire transmitter is carried with a qualified user of the computer system.

In an embodiment, the wireless receiver is integrated with the wireless receiver of a peripheral equipment in the computer system. For example, the wireless receiver is the wireless receiver of a wireless mouse pointer. In another example, the wireless receiver is the wireless receiver of a wireless keyboard device.

In an embodiment, an application program of the computer system deactivates the locked mode in response to the receipt of the specific wireless signal.

In an embodiment, an application program of the computer system deactivates the locked mode in response to the input of an identification code.

Preferably, the wireless transmitter includes a switch optionally triggered for selecting one of different wireless signals as the specific wireless signal to be issued. The wireless receiver is adjustable to conform to the specific wireless signal selected to be issued via the switch.

The present invention also provides a security system for use with a computer system, which comprises a wireless transmitter for issuing a specific wireless signal; and a wireless receiver in communication with the computer system, keeping the computer system at a normally operational mode in response to the receipt of the specific wireless signal and switching the computer system from the normally operational mode into a locked mode in response to the interruption of the specific wireless signal.

The present invention further provides a security method of a computer system. The security method comprises steps of continuously receiving a specific wireless signal; and entering a locked mode in response to the interruption of the specific wireless signal.

In an embodiment, the security method further comprises a step of deactivating the locked mode in response to the receipt of the specific wireless signal.

In an embodiment, the security method further comprises a step of deactivating the locked mode in response to the input of an identification code.

In an embodiment, the security method further comprises a step of showing a window for inputting the identification code in response to a triggering signal from a peripheral equipment of the computer system.

In an embodiment, the security method further comprises a step of adjusting the specific wireless signal on the condition that the locked mode is deactivated.

In an embodiment, the security method further comprises a step of selecting one of different wireless signals as the specific wireless signal on the condition that the locked mode is deactivated.

In an embodiment, the locked mode is to show a window for inputting an identification code.

In an embodiment, the locked mode is to activate a screen saver.

In an embodiment, the locked mode is to enter idle display.

In an embodiment, the locked mode is to enter idle input.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic diagram showing a conventional security system for use with a computer system;

FIG. 2A is a schematic diagram showing a preferred embodiment of a security system according to the present invention, which is being deactivated to switch the computer system into a normally operational mode;

FIG. 2B is a schematic diagram of the security system of FIG. 2A, which is being activated to switch the computer system into a locked mode;

FIG. 2C is a schematic diagram of the security system of FIG. 2A, which is being activated to switch the computer system into another locked mode;

FIG. 3A is a flowchart illustrating a first embodiment of a security method according to the present invention;

FIG. 3B is a flowchart illustrating a second embodiment of a security method according to the present invention;

FIG. 3C is a flowchart illustrating is a third embodiment of a security method according to the present invention;

FIG. 4A is a schematic diagram showing an embodiment of a wireless transmitter used in the security system according to the present invention;

FIG. 4B is a schematic diagram illustrating the staggering of wireless signals for different computer systems according to an embodiment of the present invention; and

FIG. 4C is a flowchart illustrating the wireless-signal switching method according to an embodiment of the present invention.

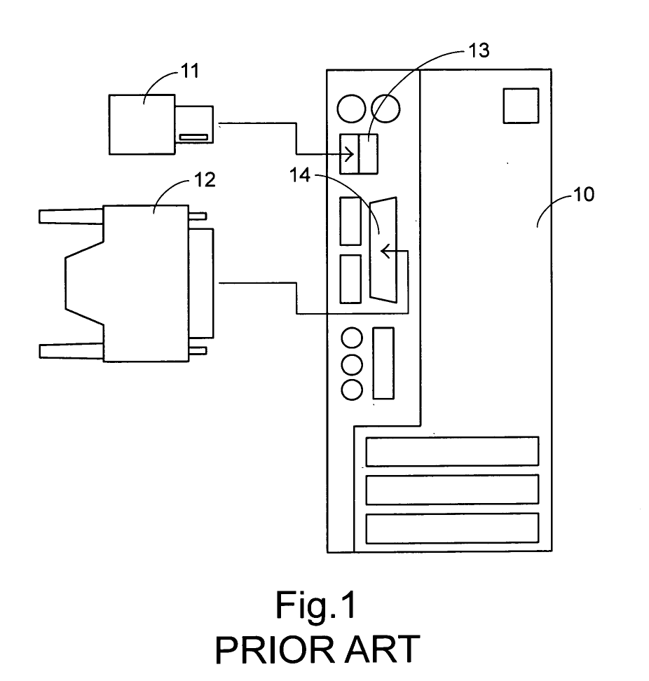

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

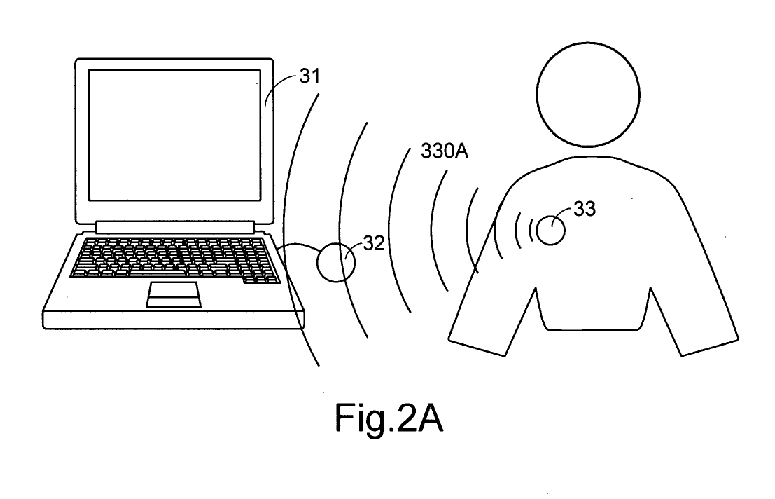

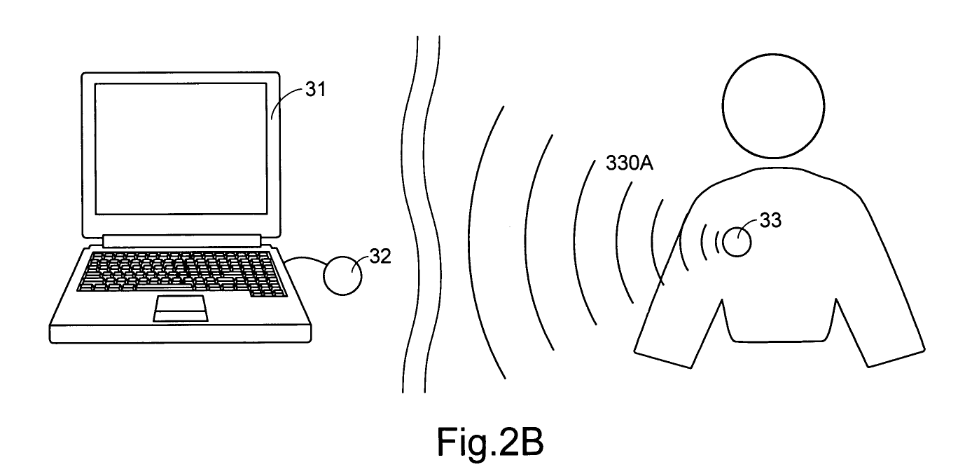

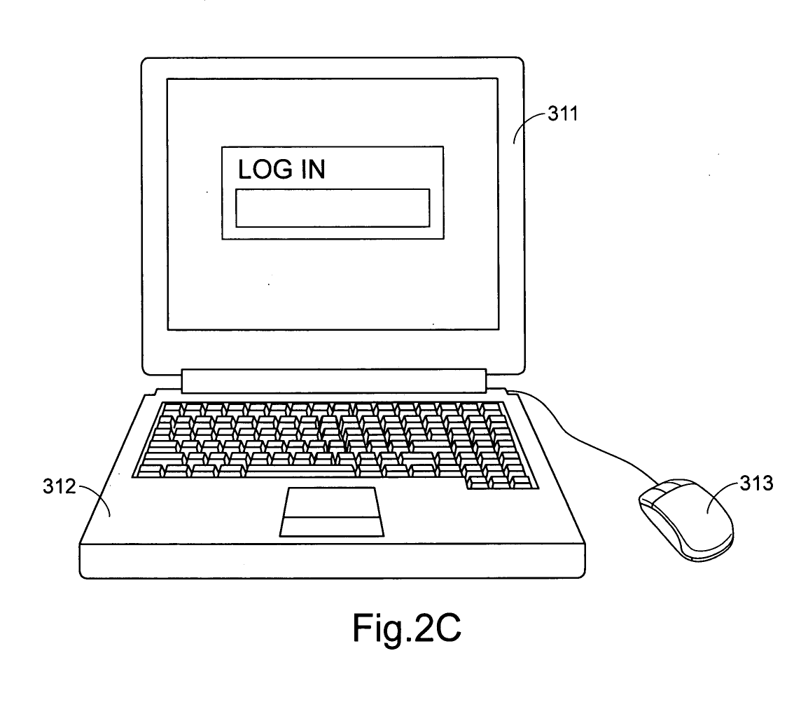

In order to achieve the security purpose in a user-friendly manner, the security means according to the present invention is implemented in an automatic and wireless transmission manner. The security system, as shown in FIG. 2A or 2B, includes a wireless transmitter 33 and a wireless receiver 32. The wireless transmitter 33 is carried with the qualified user and keeps on issuing a specific wireless signal 330A. The wireless receiver 32 is mounted to a peripheral equipment such as keyboard device or mouse pointer and communicable with the computer host 31 via the peripheral equipment.

When it is the qualified user carrying the wireless transmitter 33 using the computer, the wireless receiver 32 continuously receives the specific wireless signal 330A from the wireless transmitter 33, as shown in FIG. 2A. Meanwhile, the computer system can be booted smoothly and then work normally. Once the qualified user becomes distant from the computer system so that the wireless receiver 32 receives the wireless signal 330A no longer, as shown in FIG. 2B, the security mechanism is activated. In other words, the computer 31 is switched from a normally operational mode into a locked mode.

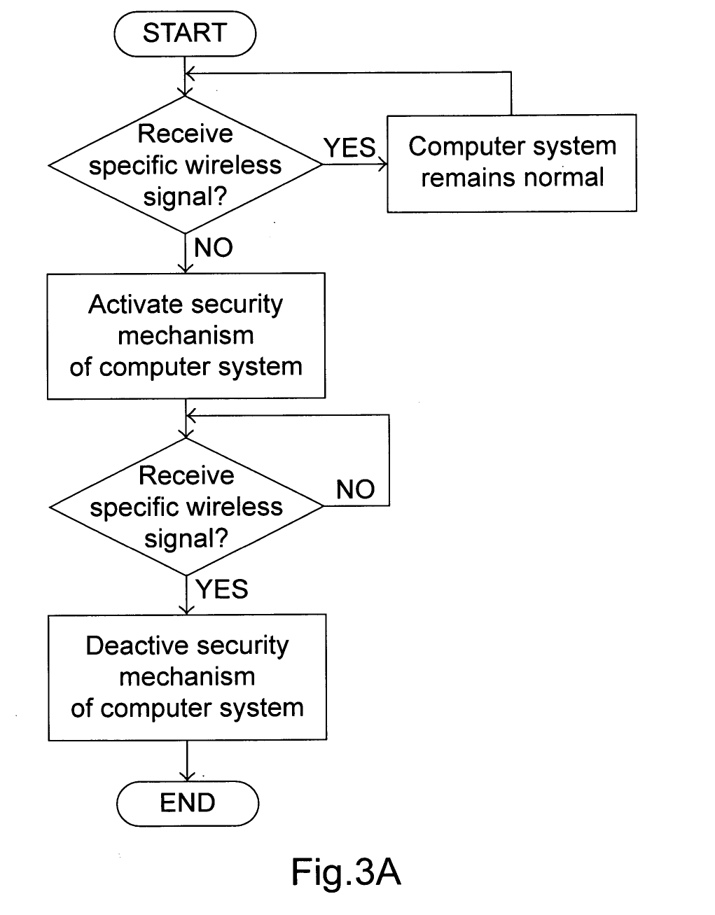

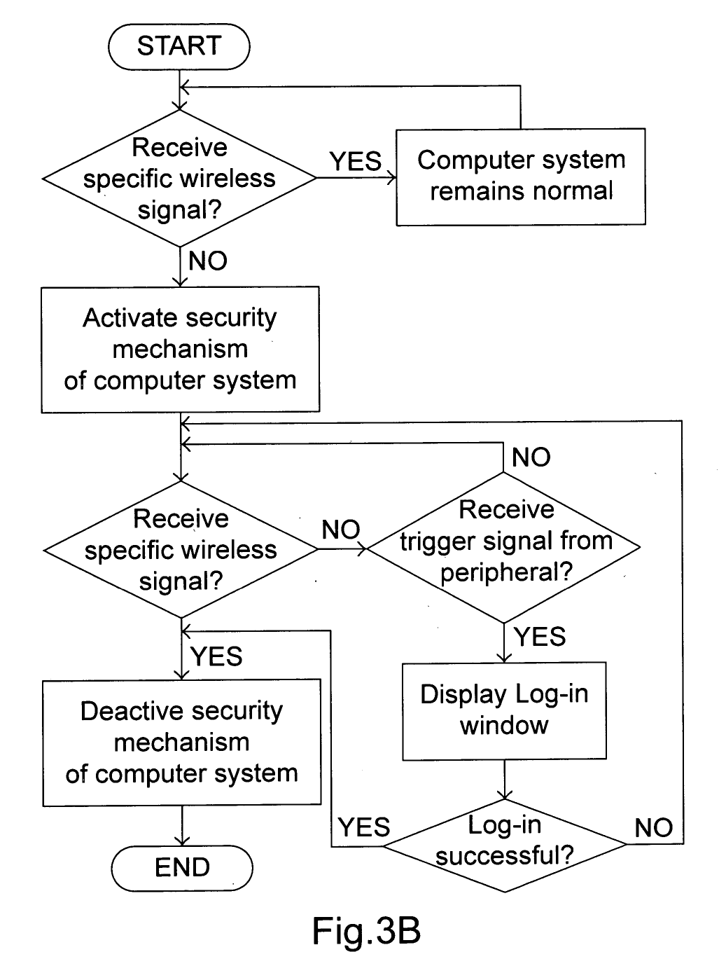

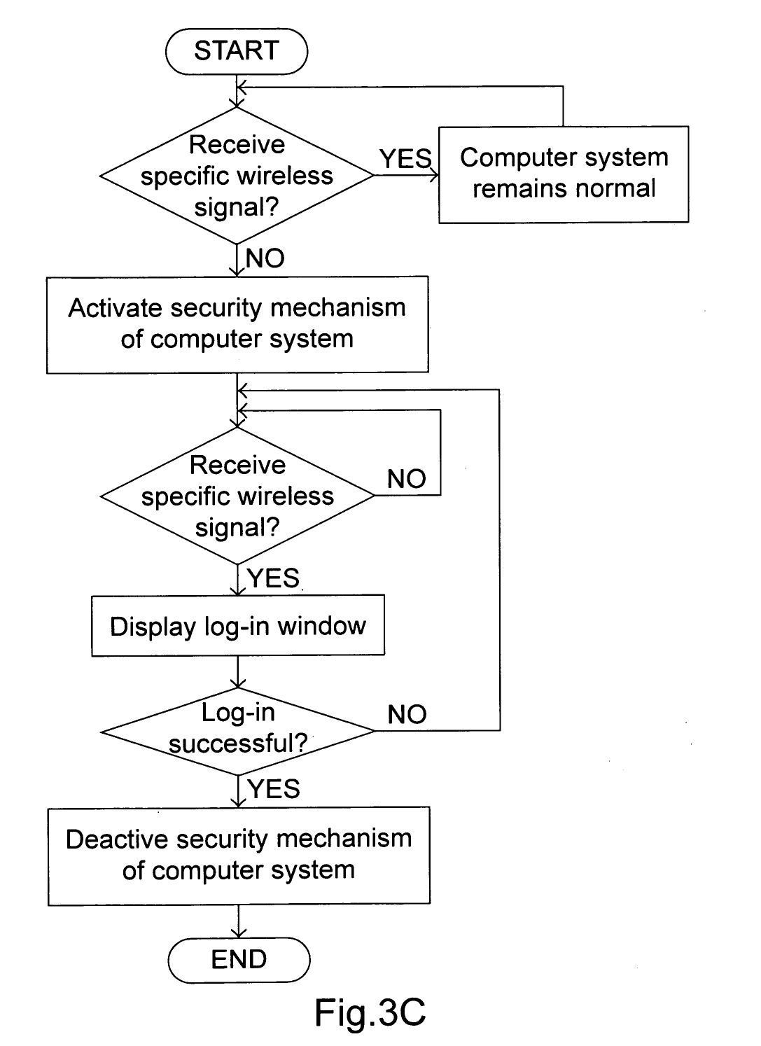

Afterwards, when the qualified user carrying the wireless transmitter 33 comes back again so that the wireless receiver 32 receives the wireless signal 330A again, the security mechanism is deactivated immediately and the computer 31 can be recovered to normally operational mode directly, as illustrated in the flowchart of FIG. 3A. Alternatively, even if the wireless signal 330A is received, the security system further requires the user to log in, e.g. enter an identification code such as username, password and/or pin number, for further security purpose. This example is illustrated with the flowchart of FIG. 3C. In another example, as illustrated in the flowchart of FIG. 3B, if the peripheral equipment such as keyboard device 312 or mouse pointer 313 is actuated by the user to issue a trigger signal to the computer 31 in the absence of the wireless signal 330A, a log-in window 311 as shown in FIG. 2C is displayed to request log-in information from the user. If the log-in information is correctly entered, i.e. log in successfully, the security mechanism can also be deactivated. This makes security means according to the present invention flexible.

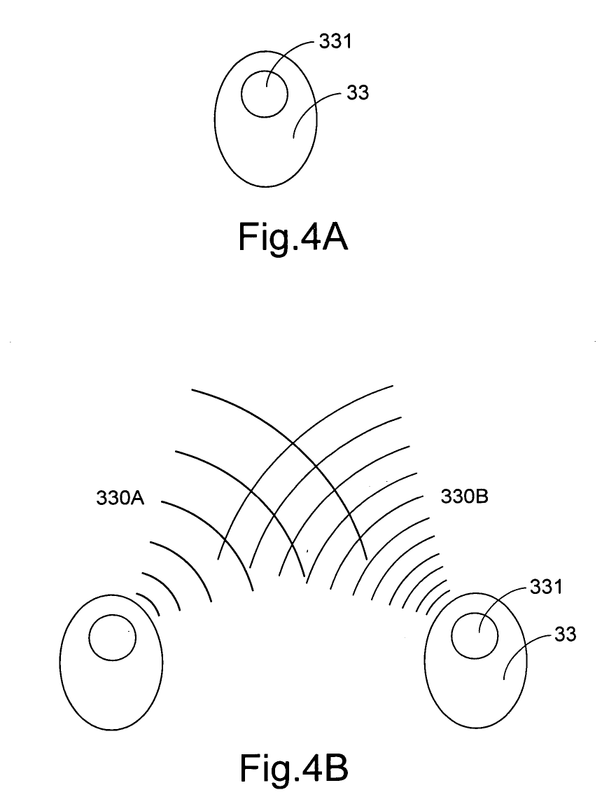

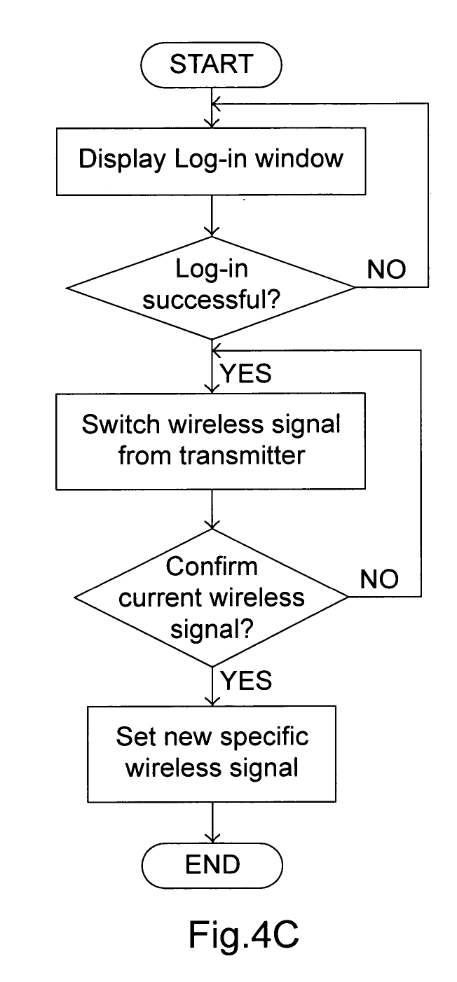

Sometimes, there is more than one computer existent at the same location at the same time. Under this circumstance, it is preferred that the wireless signals are different for operating different computers. In other words, the wireless signal is preferably adjustable. In order to achieve this purpose, a signal switch, for example implemented with a push button 331, is provided on the wireless transmitter 33 to be operated by the user. By pushing the button 331, the originally-set wireless signal 330A is adjusted or changed to another signal that is different from the wireless signal 330A in frequency, encoding format or any other suitable feature. For the wireless transmitter 33 with more than two kinds of wireless signals, the user can select one of the wireless signals as the specific wireless signal by pushing the button 331 differentially. After the specific wireless signal 330A has changed to a new specific wireless signal 330B, the wireless signals for two adjacent computers can be distinguished, as shown in FIG. 4B. However, the wireless signal 330B becomes denied by the wireless receiver 32. Therefore, for example, the log-in window is displayed to request the identification of the user. Once the user is identified to be qualified, he can modify the valid specific wireless signal to the newly set one, as illustrated in the flowchart of FIG. 4C. Meanwhile, of course, the security mechanism is deactivated.

For any of the above embodiments, various locked modes of the computer system can be entered when the security mechanism is activated. It principally implemented by entering idle display or entering idle input. For example, once the security mechanism is activated, the frame on the display is frozen or becomes blank or the screen saver is entered. Alternatively, the input from all the peripheral equipment is prohibited except for the display of the log-in window. By this way, the computer system can be protected from arbitrary use in an effective and easy way.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A security system for use with a computer system, comprising:
a wireless transmitter for issuing a specific wireless signal; and
a wireless receiver in communication with said computer system for receiving said specific wireless signal,
wherein said computer system enters a locked mode when said wireless receiver does not receive said specific wireless signal.

2. The security system according to claim 1 wherein said wire transmitter is carried with a qualified user of said computer system.

3. The security system according to claim 1 wherein said wireless receiver is integrated with the wireless receiver of a peripheral equipment in said computer system.

4. The security system according to claim 3 wherein said wireless receiver is the wireless receiver of a wireless mouse pointer.

5. The security system according to claim 3 wherein said wireless receiver is the wireless receiver of a wireless keyboard device.

6. The security system according to claim 1 wherein an application program of said computer system deactivates said locked mode in response to the receipt of said specific wireless signal.

7. The security system according to claim 1 wherein an application program of said computer system deactivates said locked mode in response to the input of an identification code.

8. The security system according to claim 1 wherein said wireless transmitter includes a switch optionally triggered for selecting one of different wireless signals as said specific wireless signal to be issued.

9. The security system according to claim 9 wherein said wireless receiver is adjustable to conform to said specific wireless signal selected to be issued via said switch.

10. A security system for use with a computer system, comprising:
a wireless transmitter for issuing a specific wireless signal; and
a wireless receiver in communication with said computer system, keeping said computer system at a normally operational mode in response to the receipt of said specific wireless signal and switching said computer system from said normally operational mode into a locked mode in response to the interruption of said specific wireless signal.

11. A security method of a computer system, comprising steps of:
continuously receiving a specific wireless signal; and
entering a locked mode in response to the interruption of said specific wireless signal.

12. The security method according to claim 11 further comprising a step of deactivating said locked mode in response to the receipt of said specific wireless signal.

13. The security method according to claim 11 further comprising a step of deactivating said locked mode in response to the input of an identification code.

14. The security method according to claim 13 further comprising a step of showing a window for inputting said identification code in response to a triggering signal from a peripheral equipment of said computer system.

15. The security method according to claim 13 further comprising a step of adjusting said specific wireless signal on the condition that said locked mode is deactivated.

16. The security method according to claim 11 further comprising a step of selecting one of different wireless signals as said specific wireless signal on the condition that said locked mode is deactivated.

17. The security method according to claim 11 wherein said locked mode is to show a window for inputting an identification code.

18. The security method according to claim 11 wherein said locked mode is to activate a screen saver.

19. The security method according to claim 11 wherein said locked mode is to enter idle display.

20. The security method according to claim 11 wherein said locked mode is to enter idle input.
